(19) United States
(12) Patent Application Publication
(10) Pub. No.: US 2007/0229416 A1
(43) Pub. Date: Oct. 4, 2007

(54) HIGH VOLTAGE HYSTERETIC LED CONTROLLER

(76) Inventor: Leonard De Oto, Springfield, OH (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/278,530

(22) Filed: Apr. 3, 2006

(51) Int. Cl. G09G 3/32

(52) U.S. Cl. 345/82

(57) ABSTRACT

Systems and methods for hysteretically controlling Light Emitting Diodes (LEDs) in a high voltage environment. An example system includes a plurality of LEDs and a circuit electrically coupled to the plurality of LEDs. The circuit hysteretically controls an input voltage supplied to the plurality of LEDs based on an input voltage and a pulse width modulation signal, when the input voltage is greater than 18 volts. The circuit includes an N-Channel or P-Channel MOSFET switch for switching on and off the input voltage supplied to the plurality of LEDs, a hysteretic controller for generating a hysteretic control signal, and a subcircuit for controlling operation of the MOSFET switch based on the generated hysteretic control signal. The subcircuit maintains an acceptable voltage differential between a gate and a source of the MOSFET switch based on the generated hysteretic control signal and the input voltage.

### BACKGROUND OF THE INVENTION

When driving Light Emitting Diodes (LED)s, it is not uncommon to have a voltage above 18V available to provide power to the LEDs. Direct drive hysteretic controllers are not able to work with this voltage due to a component limitation in the circuitry. Thus, in applications from automotive to aviation, the voltages received by a hysteretic controller must be greatly reduced to acceptable voltage levels. This adds constant complexity to the circuit needed.

Therefore, there exists a need for a hysteretic controller that is operational at voltages greater than 18V.

### SUMMARY OF THE INVENTION

The present invention provides systems and methods for hysteretically controlling Light Emitting Diodes (LED)s in a high voltage environment. An example system includes a plurality of LEDs and a circuit electrically coupled to the plurality of LEDs. The circuit hysteretically controls an input voltage supplied to the plurality of LEDs based on an input voltage and a pulse width modulation signal, when the input voltage is greater than 18 volts.

In one aspect of the invention, the circuit includes an N-Channel or P-Channel MOSFET switch for switching on and off the input voltage supplied to the plurality of LEDs, a hysteretic controller for generating a hysteretic control signal, and a subcircuit for controlling operation of the N-Channel or P-Channel MOSFET switch based on the generated hysteretic control signal. The subcircuit maintains an acceptable voltage differential between a gate and a source of the N-Channel or P-Channel MOSFET switch based on the generated hysteretic control signal and the input voltage.

### BRIEF DESCRIPTION OF THE DRAWINGS

The preferred and alternative embodiments of the present invention are described in detail below with reference to the following drawings:

FIG. 1 illustrates an LED controller circuit in accordance with embodiment of the present invention;

FIGS. 2A and 2B illustrate an embodiment of the controller circuit shown in FIG. 1; and

FIGS. 3A and 3B illustrate another embodiment of the circuit component shown in FIG. 1.

### DETAILED DESCRIPTION OF THE PREFERRED EMBODIMENT

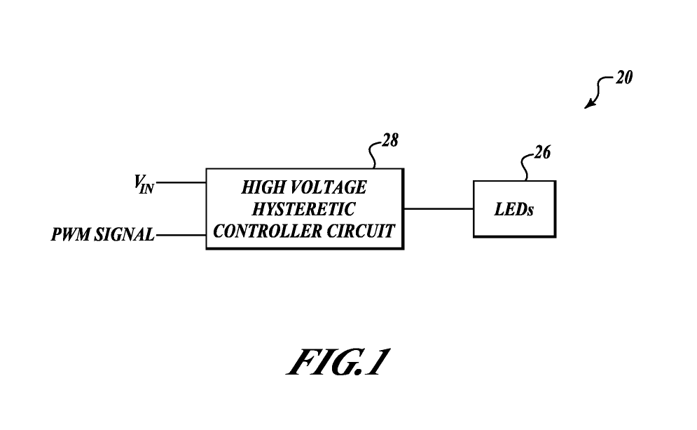

FIG. 1 illustrates a Light Emitting Diode (LED) system 20 for performing hysteretic control in a high voltage environment, thereby allowing control of a plurality of LEDs 26. The system 20 includes a high voltage hysteretic controller circuit 28 that receives an Input Voltage (V_{IN}) and a Pulse Width Modulation (PWM) signal. The high voltage hysteretic controller circuit 28 is capable of receiving a V_{IN} equal to or greater than 18V.

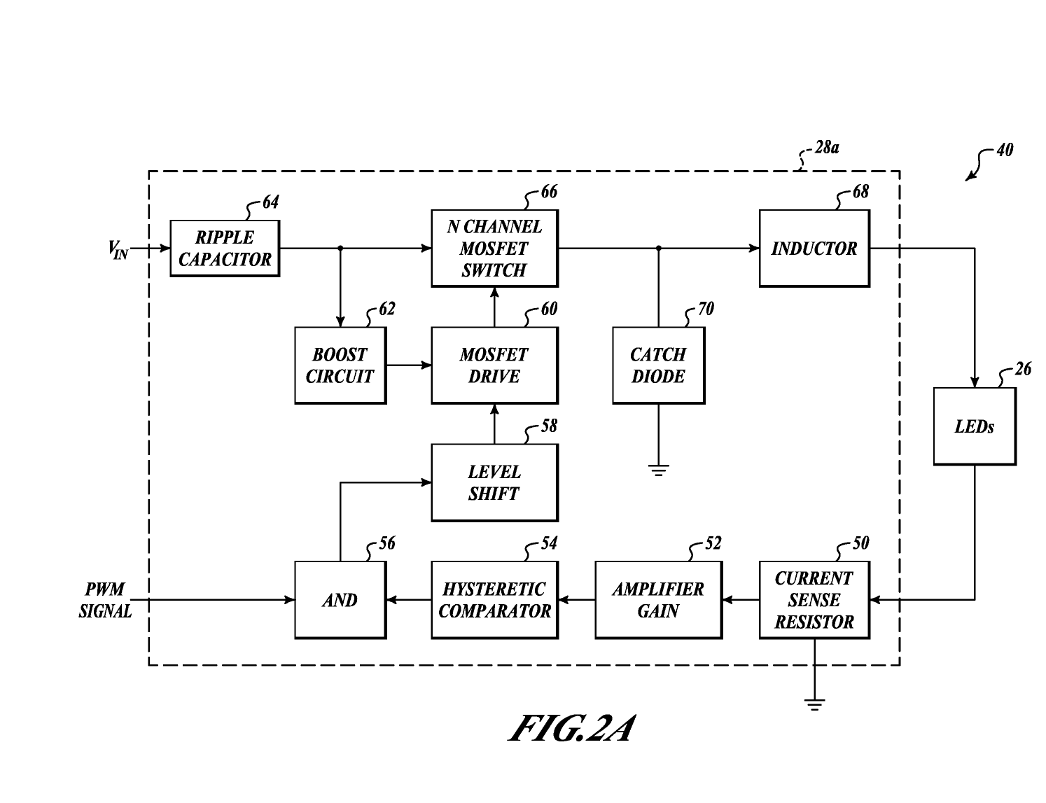

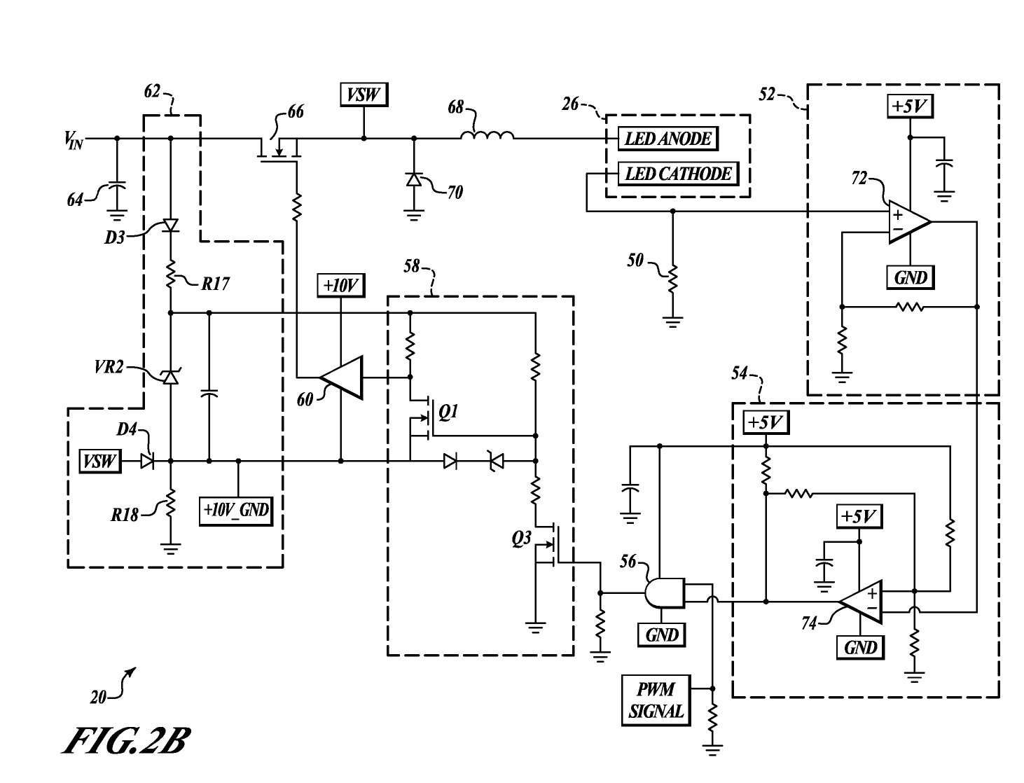

FIG. 2A illustrates a block diagram of an example system 40 for controlling a plurality of LEDs 26 with an input voltage V_{IN} that is equal to or greater than 18V. The plurality of LEDs 26 are coupled to a hysteretic controller circuit 28a. The hysteretic controller circuit 28a includes an optional ripple capacitor 64 that receives the V_{IN}, a boost circuit 62, a MOSFET drive component 60, a level shift circuit 58, an AND gate 56 that receives the PWM signal, a hysteretic comparator 54, an amplifier 52, a current sense resistor 50, a catch diode 70, and an inductor 68.

The current sense resistor 50 senses the current passing through the LEDs 26. The output of the current sense resistor 50 is coupled to an input of the amplifier 52, which provides an output to an input of the hysteretic comparator 54. The output of the hysteretic comparator 54 and the PWM signal are supplied to the AND gate 56 and the results of the AND gate 56 are provided to the level shift circuit 58. The MOSFET drive component 60 controls the MOSFET switch 66 based on input from the boost circuit 62 and the level shift circuit 58. The MOSFET switch 66 then drives the inductor 68 and thus the LEDs 26. The level shift circuit 58 allows the MOSFET drive component 60 to float, or in other words, to keep the MOSFET drive component 60 in a safe range.

FIG. 2B illustrates an example of detailed circuitry for each of the components shown in FIG. 2A. The current sensor 50, the amplifier 52, the hysteretic comparator 54, and the AND gate 56 are described in more detail in co-pending U.S. patent application Ser. Nos. 11/069,298 filed Mar. 1, 2005 and 11/818,815 filed Jul. 15, 2005, the contents of which are hereby incorporated by reference. The AND gate 56 is used to control (Pulse Width Modulate) the circuit 20. The hysteretic comparator 54 has a high output initially. Thus when the PWM input becomes a logic ‘1’, the output of the AND gate becomes a logic ‘1’, causing a MOSFET Q3 to turn on in the level shift circuit 58 and the gate of a second transistor Q1 in the level shift circuit 58 to fall to +10V_GND, or below, shutting it off The input to the drive component 60 rises to a logic ‘1’, thus performing a level shifting action. The output of the drive component 60 becomes high, turning on the MOSFET switch 66. The MOSFET switch 66 controls the application of the high input voltage to the LEDs 26. When the MOSFET switch 66 is on, the input voltage V_{IN} is impressed across the inductor 68, the LEDs 26, and the current sense resistor 50. While the voltage is applied, the current begins to ramp up due to presence of the inductor 68. The LEDs 26 light and the resistor 50 creates a voltage ramp that is proportional to the current through the LEDs 26. An Operational Amplifier (OpAmp) 72 is connected to a cathode of the LEDs 26. The OpAmp 72 increases the signal-to-noise ratio of the ramped current signal. The output of the OpAmp 72 is received at an input of a comparator 74 in the hysteretic comparator 54. When the voltage of the ramped signal exceeds the upper threshold of the comparator 74, the output of the comparator 74 falls. This places a logic ‘0’ on the input to the AND gate 56, causing the output of the AND gate 56 to become a logic ‘0’, thus turning off the MOSFET Q3. Turning off the MOSFET Q3 causes the MOSFET Q1 to turn on since its gate is now allowed to pull-up to +10V and the input to the drive component 60 to become a logic ‘0’ and the output will become low (as referenced to +10V_GND and VSW). VSW denotes a voltage switching node that is created where the MOSFET switch 66, the free-wheeling diode 70, and the inductor 68 are joined. The node will switch voltage between the input (minus a small drop across the MOSFET switch 66) and ground (minus a small drop across the diode 70) depending on whether the MOSFET switch 66 is ON or OFF.

The low output of the drive component 60 turns off the switch 66, which causes the inductor 68 to reverse polarity and begin to source its stored energy to the LEDs 26 and resistor 50 using the diode 70 to complete the circuit. The resistor 50 senses the current and the OpAmp 72 provides a gained-up voltage version of the current ramp to the hysteretic comparator 54. When the voltage ramp falls to the lower threshold of the comparator 54, the output then goes back high, placing a logic ‘1’ on the input of the AND gate 56. The cycle then repeats itself as long as the PWM input remains high. Diodes D3, VR2 and resistors R17 and R18 are used to create a 10V supply to power the MOSFET drive component 60. The entire circuit is referenced to the switching node (VSW) by a diode D4, which allows the MOSFET drive component 60 to float with the source connection of the MOSFET it is controlling.

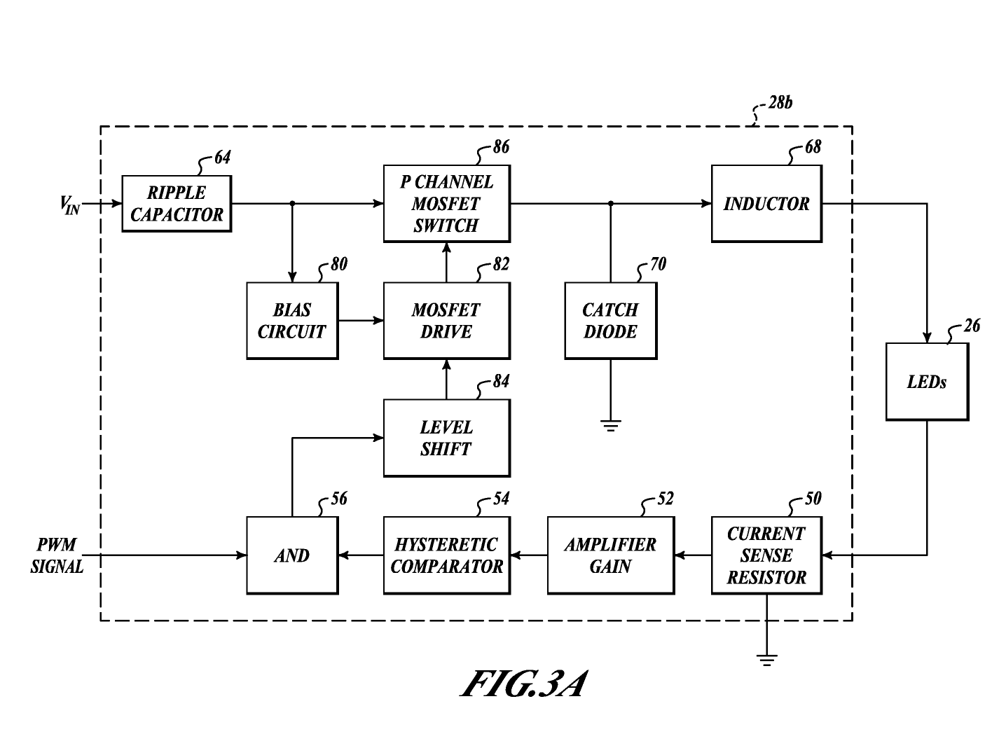

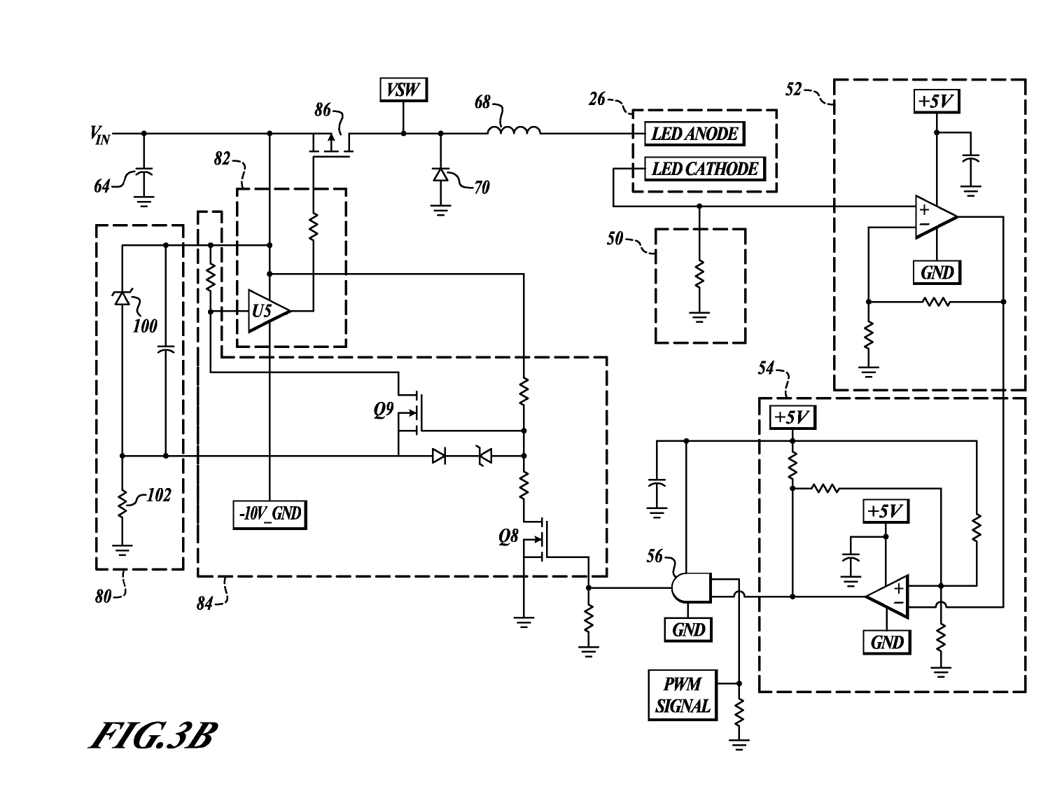

FIGS. 3A and 3B illustrate an embodiment of the present invention using a P-Channel circuit 28b. The P-Channel circuit 28b is similar to the N-Channel circuit described above except for some small differences. The circuit 28b includes the ripple capacitor 64 that receives the V_{IN}, a bias circuit 80, a MOSFET drive component 82, a level shift circuit 84, the AND gate 56 that receives the PWM signal, the hysteretic comparator 54, the amplifier gain 52, the current sense resistor 50, the catch diode 70, and the inductor 68.

When the hysteretic comparator 54 and the PWM signal want a P-Channel MOSFET 86 to be on, they apply logic ‘1’s to the AND gate 56, which causes a transistor Q8 in the level shift circuit 84 to turn on. Turning the transistor Q8 on causes a transistor Q9 also in the level shift circuit 84 to shut off. An OpAmp U5 in the MOSFET drive component 82 rises to a logic ‘1’. The output of the OpAmp U5 is forced to reference (−10V_GND) causing the P-Channel MOSFET 86 to turn on. The LEDs 26 light and the components 52, 54, and 56 function as described above. When the hysteretic comparator 54 switches and places a logic ‘0’ on its output, and the AND gate 56 places a logic ‘0’ on its output. The transistor Q8 turns off. The gate of the transistor Q9 is pulled up, turning it on, and applying a logic ‘0’ to the input of the OpAmp U5. The output of the OpAmp U5 is forced to its upper rail (which is the Input Voltage). The P-Channel MOSFET 86 turns off and the stored energy in the inductor 68 is used to continue powering the LEDs 26. Once the bottom current limit of the hysteretic comparator 54 is met, its output becomes a logic ‘1’ and the cycle repeats. A diode 100 and resistor 102 in the bias circuit 80 create a floating voltage source to power the OpAmp U5.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A Light Emitting Diode (LED) system comprising:
a plurality of LEDs; and
a circuit electrically coupled to the plurality of LEDs for hysteretically controlling an input voltage supplied to the plurality of LEDs based on the input voltage and a pulse width modulation signal,
wherein the input voltage is greater than 18 volts.

2. The system of claim 1, wherein the circuit comprises:
an N-Channel MOSFET switch for switching on and off the input voltage supplied to the plurality of LEDs;
a hysteretic controller for generating a hysteretic control signal; and
a subcircuit for controlling operation of the N-Channel MOSFET switch based on the generated hysteretic control signal and for maintaining an acceptable voltage differential between a gate and a source of the N-Channel MOSFET switch based on the generated hysteretic control signal and the input voltage.

3. The system of claim 2, wherein the acceptable voltage differential is less than 18 volts.

4. The system of claim 1, wherein the circuit comprises:
a P-Channel MOSFET switch for switching on and off the input voltage supplied to the plurality of LEDs;
a hysteretic controller for generating a hysteretic control signal; and
a subcircuit for controlling operation of the P-Channel MOSFET switch based on the generated hysteretic control signal and for maintaining an acceptable voltage differential between a source and a gate of the P-Channel MOSFET switch based on the generated hysteretic control signal and the input voltage.

5. The system of claim 4, wherein the acceptable voltage differential is less than 18 volts.

6. A method for controlling a plurality of Light Emitting Diodes (LEDs), the method comprising:
sensing current passing through the LEDs; and
hysteretically controlling the plurality of LEDs based on an input voltage and a pulse width modulation signal,
wherein the input voltage is greater than 18 volts.

7. The method of claim 6, wherein hysteretic controlling comprises:
generating a hysteretic control signal based on the sensed current;
controlling operation of an N-Channel MOSFET switch based on the generated hysteretic control signal; and
maintaining an acceptable voltage differential between a gate and a source of the N-Channel MOSFET switch based on the generated hysteretic control signal and the input voltage.

8. The method of claim 7, wherein the acceptable voltage differential is less than 18 volts.

9. The method of claim 6, wherein hysteretic controlling comprises:
generating a hysteretic control signal based on the sensed current;
controlling operation of an P-Channel MOSFET switch based on the generated hysteretic control signal; and
maintaining an acceptable voltage differential between a source and a gate of the P-Channel MOSFET switch based on the generated hysteretic control signal and the input voltage.

10. The method of claim 9, wherein the acceptable voltage differential is less than 18 volts.
